(19) United States
(12) Patent Application Publication
(10) Pub. No.: US 2012/0079365 A1
(43) Pub. Date: Mar. 29, 2012

(54) IMAGE FORMING CONTROL PROGRAM, METHOD OF IMAGE FORMING CONTROL AND IMAGE PROCESSING APPARATUS

(75) Inventor: Akidi YOSHIDA, Nagoya-shi (JP)

(73) Assignee: BROTHER KOGYO KABUSHIKI KAISHA, Aichi-ken (JP)

(21) Appl. No.: 13/075,543

(22) Filed: Mar. 30, 2011

(30) Foreign Application Priority Data
Sep. 27, 2010 (JP) 2010-215265

(51) Int. Cl. G06F 3/14

(52) U.S. Cl. 715/234

(57) ABSTRACT

A non-transitory computer-readable medium having instructions to control a computer, which is configured to display an image represented by webpage data, to perform a method of image forming control, the method including: controlling, when an operation unit receives a operation designating a specific image associated with term, a first acquiring unit to acquire the term associated with the specific image; controlling a storage unit to store: term information; term acquiring information; specific image data acquiring information; and webpage data specifying information; controlling, when the webpage data specified by the webpage data specifying information is provided by the providing source, a second acquiring unit to acquire the term from said webpage data; and controlling, when the term acquired by the second acquiring unit is updated from the term indicated by the term information, a specific image data acquiring unit to acquire the specific image data from the webpage data.

### CROSS-REFERENCE TO RELATED APPLICATION

This application claims priority from Japanese Patent Application No. 2010-215265 filed on Sep. 27, 2010, the entire subject matter of which is incorporated herein by reference.

### TECHNICAL FIELD

The present invention relates to an image forming processing program for designating and processing an image displayed on a webpage image.

### BACKGROUND ART

A related art discloses a technology in which a user's intended range is designating (clipping) from a webpage image displayed on a monitor of a personal computer (PC) and storing and printing an image within the designated range.

### SUMMARY

A specific image associated with term information is often displayed on the webpage image. An example of the specific image is a coupon having the expiration date. The coupon is information for getting benefits, for example, discounts of purchasing price, exchanges of free gifts and the like. In addition, the term information associated with the specific image may be often updated. For example, the expiration date of the coupon is updated, so that the expiration date may be extended.

In other words, when clipping and storing the specific image in the PC, it is necessary to manage the clipped specific image by using the term information. For example, when storing the coupon as a clip image, it is necessary to manage whether the expiration date of the coupon is updated or expired. But the managing at every time is a trouble to a user. In the meantime, A related art does not disclose a technology to manage the clipped image by using the term information and the like. Accordingly, the present invention provides a technology to reduce the above inconvenience.

In an exemplary aspect of the present invention, a non-transitory computer-readable medium having instructions to control a computer, which is configured to display an image represented by webpage data, which is provided from a providing source of the webpage data, on a display unit, to perform a method of image forming control, the method including: controlling, when an operation unit receives a operation designating a specific image associated with term that is a partial image being at least a part of the webpage image, a first acquiring unit to acquire the term associated with the specific image received by the operation unit; controlling a storage unit to store: term information indicating the term acquired by the first acquiring unit; term acquiring information to acquire the term from the webpage data by the same process as the first acquiring unit; specific image data acquiring information to acquire specific image data corresponding to the specific image from the webpage data; and webpage data specifying information to specify either webpage data; controlling, when the webpage data specified by the webpage data specifying information is provided by the providing source, a second acquiring unit to acquire the term from said webpage data, by using the term acquiring information stored in the storage unit; and controlling, when the term acquired by the second acquiring unit is updated from the term indicated by the term information, a specific image data acquiring unit to acquire the specific image data from the webpage data, by using the specific image data acquiring information stored in the storage unit.

According to the exemplary aspect of the present invention, when the computer is operated to perform above-described functions by the program, it is possible to store the specific image data having the latest term information in the storage unit at all times. In other words, it is possible to manage the specific image data based on the term information. Accordingly, it is possible to prevent a user from using the specific image data associated with the old term information.

### BRIEF DESCRIPTION OF THE DRAWINGS

FIG. 1 is a block diagram showing a configuration of a communication system;

FIG. 2 illustrates a first operating flowchart of the clip application;

FIG. 3 illustrates a second operating flowchart of the clip application;

FIG. 4 illustrates a third operating flowchart of the clip application;

FIG. 5 illustrates a fourth flowchart of the clip application;

FIG. 6 illustrates a fifth operating flowchart of the clip application;

FIG. 7 illustrates a sixth operating flowchart of the clip application;

FIG. 8 illustrates a seventh operating flowchart of the clip application;

FIG. 9 illustrates an eighth operating flowchart of the clip application;

FIG. 10 illustrates a ninth operating flowchart of the clip application;

FIG. 11 is a view showing an example of a clip information table; and

FIG. 12 is a view showing a display example of a webpage image.

### DESCRIPTION OF PREFERRED ILLUSTRATIVE ASPECTS

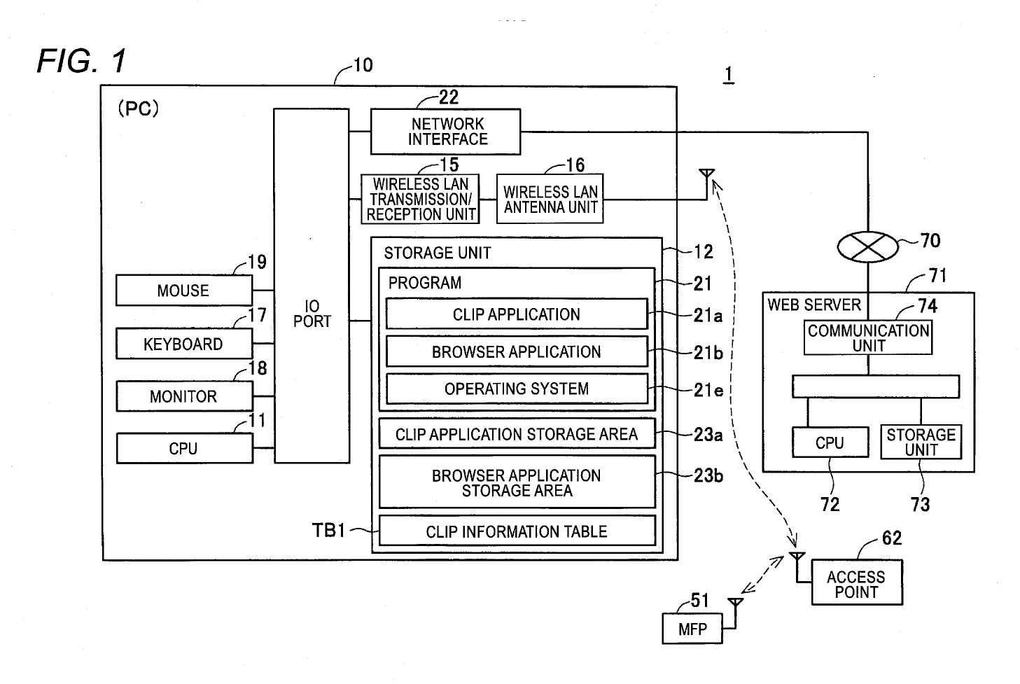

FIG. 1 shows a block diagram of a communication system 1 that exemplifies an illustrative aspect of the present invention. The communication system 1 includes a personal computer (PC) 10, a multifunction peripheral (MFP) 51, an access point 62 and a web server 71. The MFP 51 has printer, scanner, copier and facsimile functions and the like. The access point 62 is a known relay apparatus.

The PC 10 and the access point 62 can perform wireless communication by a wireless LAN method. In addition, the MFP 51 and the access point 62 can perform wireless communication by the wireless LAN method. Additionally, the PC 10 and the web server 71 are connected to communicate with each other via an internet 70.

A configuration of the PC 10 will be described. The PC 10 mainly has a CPU 11, a storage unit 12, a wireless LAN transmission/reception unit 15, a wireless LAN antenna unit 16, a keyboard 17, a monitor 18, a mouse 19 and a network interface 22.

The CPU 11 controls the respective functions by programs stored in the storage unit 12, various signals transmitted and received via the wireless LAN transmission/reception unit 15, and the like. In the meantime, the storage unit 12 may be configured by a combination of a random access memory (RAM), a read only memory (ROM), a flash memory, a hard disk drive (HDD) and the like.

The wireless LAN transmission/reception unit 15 performs the wireless communication via the wireless LAN antenna unit 16. By the wireless LAN transmission/reception unit 15, digital signals configuring various data are transmitted and received. In addition, the network interface 22 performs a variety of communications with the web server 71 via the internet 70. The keyboard 17 is keys for executing the respective functions of the PC 10. The monitor 18 displays a variety of function information of the PC 10. The mouse 19 is a known device for inputting a user's operation.

The storage unit 12 has a clip application storage area 23a, a browser application storage area 23b and a clip information table TB1. The clip application storage area 23a is an area that stores clip image data CI1, which will be described below, and the like. The browser application storage area 23b is an area that stores internet information (temporary files) for a browser application 21b. Data of a webpage is stored as cash data in the browser application storage area 23b. When re-opening a webpage that has been recently visited, the cash data is displayed without re-downloading the data from the web server 71. Thereby, it is possible to increase the display speed of the web page and to prevent congestion of the internet 70.

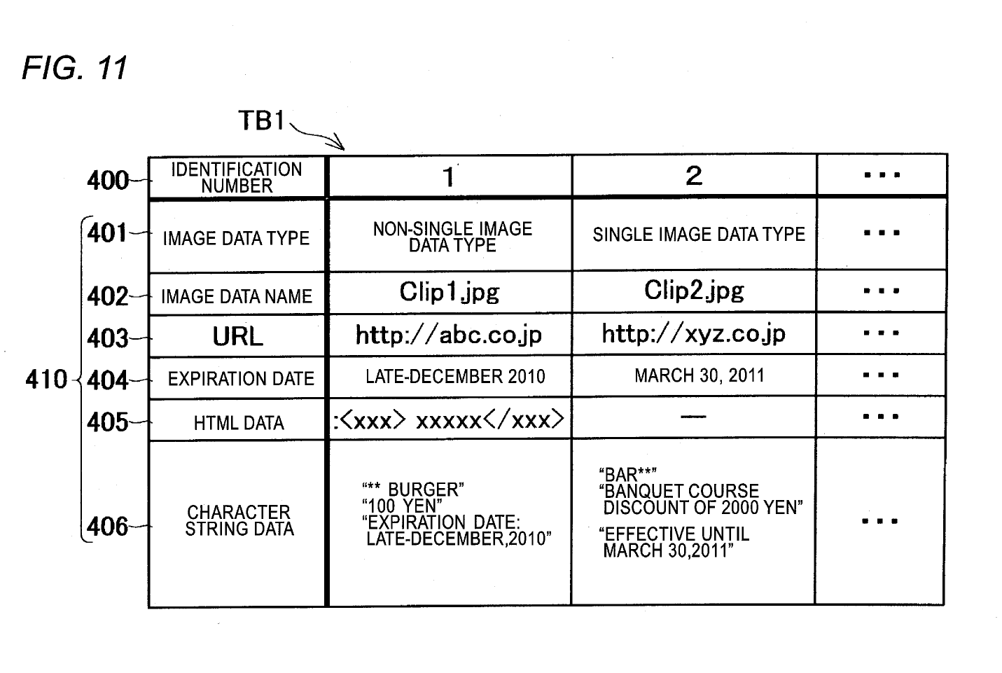

FIG. 11 is a view showing an example of the clip information table TB1. The clip information table TB1 is a table that stores clip information 410 corresponding to the clip image data CI1 The clip information table TB1 stores an identification number 400 and clip information 410. The identification number 400 is a number for identifying each of the plurality of clip information 410. The clip information 410 includes an image data type 401, an image data name 402, a URL (Uniform Resource Locator) 403, an expiration date 404, HTML (Hyper-Text Markup Language) data 405 and character string data 406.

The image data type 401 is information for identifying whether a type of the clip image data CI1 is a single image data type or a non-single image data type. The clip image data CI1 of a single image data type is image data that is acquired by clipping an image consisting of only one image data. For example, when the HTML data indicating a designated area is a content that designates only one reference image data, the clip image data CI1 that is generated by clipping the designated area becomes a single image data type. Here, an example of the HTML data having a content designating only one reference image data will be described below.

<IMG border=0 hspace=1 vspace=1
src=“http://mcd.com/coupon/coupon62.gif”
width=170 height=292>

In the above HTML data, displaying the reference image data of “http://mcd.com/coupon/coupon62.gif” is designated by a “src” attribute. In the meantime, the image displayed by the reference image data may include a character string indicating the expiration date and the like.

In the meantime, the clip image data CI1 of a non-single image data type is image data that is acquired by clipping an image having combined a plurality of image data or clipping an image displayed by the HTML data including character string data. For example, when the HTML data displaying a designated area includes a content that designates a plurality of reference image data, the clip image data CI1 that is generated by clipping the designated area becomes a non-single image data type. Here, an example of the HTML data having a content designating a plurality of reference image data will be described below.

<TD><IMG border=0 hspace=1 vspace=1
src=“http://mcd.com/coupon/coupon32.gif”
width=170 height=292></TD>
<TD><IMG border=0 hspace=1 vspace=1
src=“http://mcd.com/coupon62.gif”
width=170 height=292></TD>

In the above HTML data, displaying the two reference image data of “http://mcd.com/coupon/coupon32.gif” and “http://mcd.com/coupon62.gif” is designated by the “src” attribute.

In addition, for example, when the HTML data displaying a designated area includes data displaying a character string, the clip image data CI1 that is generated by clipping the designated area becomes a non-single image data type. Here, an example of the HTML data including data displaying a character string will be shown below.

<DD id=couponLabel><IMG title=coupon alt=coupon
src=“//gnv.com/r_c.png”>
</DD>
<DD id=couponContent sizcache=“11” sizset=“14”>
<OL sizcache=“11” sizset=“14”>
<LI>1)&nbsp; price discount ¥2,000 </LI></OL></DD>
<DD id=couponLimit> * the expiration date 2010.10.31
<DD id=couponCaution sizcache=“11” sizset=“17”>
<UL class=clfix sizcache=“11” sizset=“17”>
<LI>* please show when entering a store.</LI></UL>

The HTML data includes character string data such as “price discount ¥2,000”, “*the expiration date 2010.10.31” and “* please show when entering a store.” By the character string data, the character strings are displayed in the designated area.

The image data name 402 is a data name of the clip image data CI1 to which the clip information 410 corresponds. The URL 403 is a URL of the webpage data having acquired the clip image data CI1 The expiration date is term information that is made to correspond to the clip image data CI1 The HTML data 405 is markup language data for describing a webpage, which is obtained from the clip image data CI1 The character string data 406 is data indicating a character string extracted from the clip image data CI1.

The storage unit 12 stores a program 21. The CPU 11 executes a process in response to the program 21 in the storage unit 12. The program 21 includes a clip application 21a, a browser application 21b and an operating system 21e.

The clip application 21a is an application for executing a clip process and the like that will be described later. The browser application 21b is an application for displaying a webpage image on the monitor 18. The CPU 11 executes a process in response to the browser application 21b. In this process, the HTML data is downloaded from a web server (for example, web server 71) and the reference image data that is referred to by a data reference tag in the HTML data is downloaded from a reference source.

The CPU 11 stores the downloaded HTML data, the reference image data and the like, in the browser application storage area 23b. In addition, the CPU 11 makes up webpage image data by using the HTML data, the reference image data and the like and displays the webpage image on the monitor 18 based on the made webpage image data.

The operating system 21e is a program that provides basic functions, which are commonly used in the clip application 21a and the browser application 21b. The CPU 11 manages to pass the image data and the like between the clip application 21a and the browser application 21b in accordance with the operating system 21e.

A configuration of the web server 71 will be described. The web server 71 mainly has a CPU 72, a storage unit 73 and a communication unit 74. In the network, the web server 71 is an apparatus that provides a client apparatus with the webpage data (HTML data and reference image data) kept in the web server and various functions. The CPU 72 controls the respective functions. The storage unit 73 stores therein various HTML data, reference image data and the like. The communication unit 74 communicates a variety of information with the PC 10.

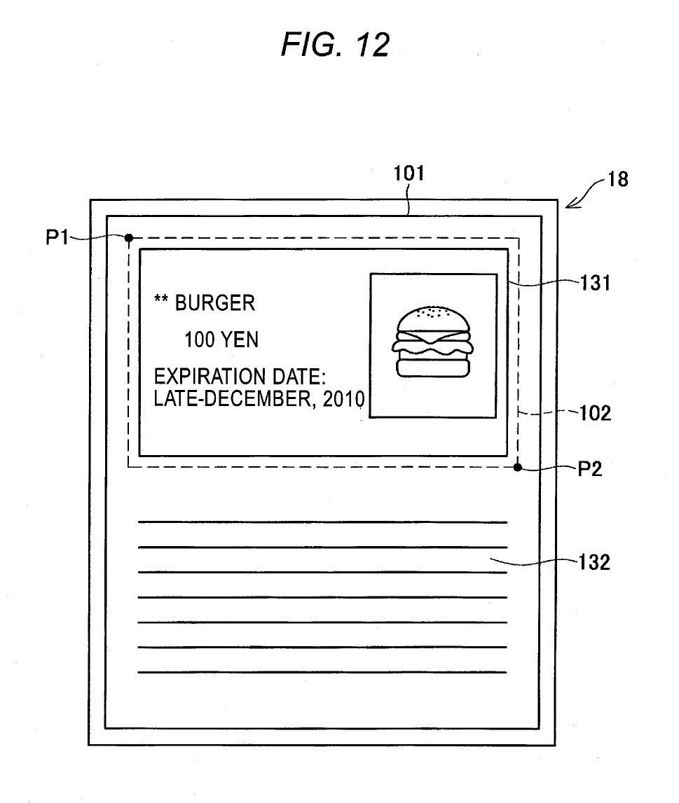

An operation of the communication system 1 according to this illustrative aspect will be described. FIG. 12 shows an example of a webpage image 101 that is displayed on the monitor 18. The webpage image 101 as shown in FIG. 12 is an image that the CPU 11 functioning in response to the browser application 21b makes the HTML data received from the web server 71 into image data and then displays the same on the monitor 18. In the webpage image 101 of FIG. 12, a coupon image 131 and a character string 132 are displayed. In this illustrative aspect, a case will be described in which a type of the coupon image 131 is a non-single image data type.

### (Acquiring Process of Clip Image Data CI1)

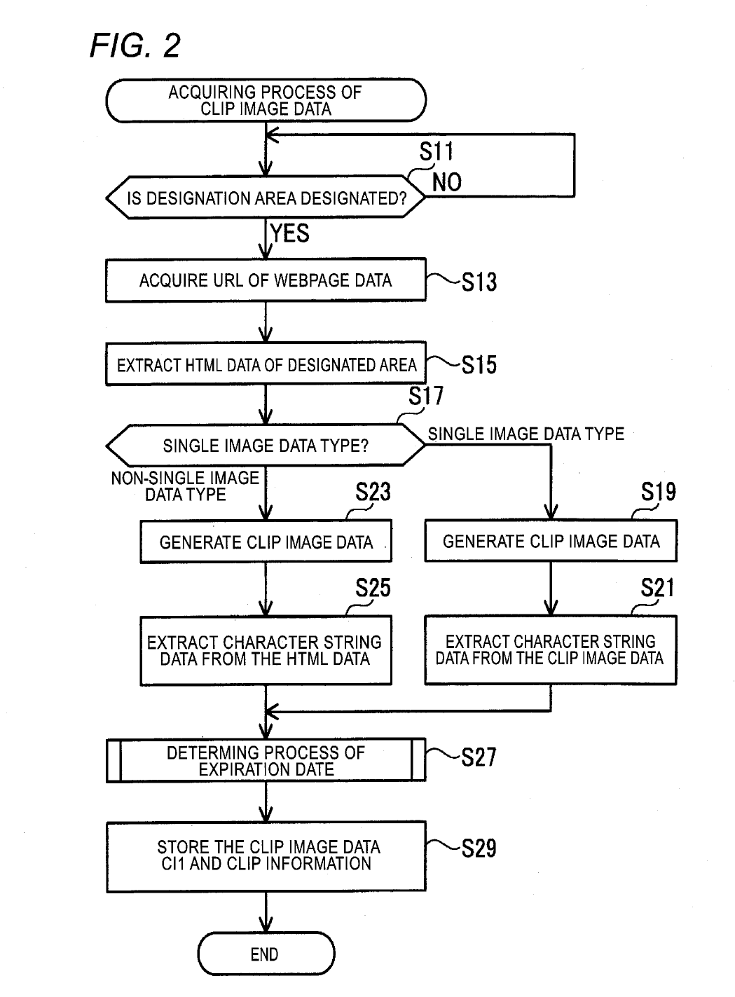

An acquiring process of the clip image data CI1 (refer to FIG. 2) starts as the clip application 21a starts up. In step S11, the CPU 11 determines whether a user designates a designation area from the webpage image 101 displayed on the monitor 18. The designation area is designated by an input device such as mouse 19. For example, a method of designating the designation area 102 shown in FIG. 12 will be described. A user moves a cursor to a starting point P1 on the webpage image 101 and then moves the cursor in a right-lower direction of the monitor 18 while pushing a button of the mouse 19. Then, the user releases the pushing of the button of the mouse 18 at an end point P2, so that the designation area 102 is designated. When the designation area 102 is not designated (step S11: NO), the process returns to step S11 and stands by. When the designation area is designated (step S11: YES), the processing proceeds to step S13.

In step S13, the CPU 11 acquires the URL of the webpage data for displaying the webpage image 101. In step S15, the CPU 11 extracts HTML data for generating an image included in the designation area. In step S17, the CPU 11 analyzes the extracted HTML data to determine whether the type of the image data clipped by the designation area 102 is a single image data type or non-single image data type.

When it is determined in step S17 that the type of the image data is a single image data type, the processing proceeds to step S19. In step S19, the CPU 11 generates the clip image data that is image data within a range of the designation area 102. The process of generating the clip image data CI1 is a known process of acquiring the image data (bit map data) that is a base of the webpage image 101 displayed on the monitor 18. For example, the process includes a process in which the CPU 11 acquires the image data that is a base of the webpage image 101 displayed on the monitor 18 in accordance with the API of the operating system 21e (alternatively, the CPU 11 may acquire the image data that is a base of the entire image displayed on the monitor 18 and extract only the image data corresponding to the webpage image 101) or a process in which the CPU 11 accesses an image memory for displaying an image on the monitor 18 and reads out and extracts the image data basing an image in an area surrounded by the designation area 102 from the image data stored in the image memory.

In step S21, the CPU 11 analyzes the clip image data CI1 and extracts the character string data. Specifically, the CPU 11 identifies the character string based on a shape of a character from the clip image data CI1 by the OCR (Optical Character Reader) processing. Then, the CPU 11 converts the identified character string into character string data that can be dealt on a computer. Then, the processing proceeds to step S27.

On the other hand, when it is determined in step S17 that the type of the image data is a non-single image data type, the processing proceeds to step S23. In step S23, the CPU 11 generates the clip image data CI1 that is image data within a range of the designation area 102. Since the process of generating the clip image data CI1 is the same as that described in step S19, the descriptions thereof will be omitted. In the meantime, even when the type of the clipped image data is a non-single image data type, the CPU 11 generates the clip image data CI1 This is because, when the HTML data of the clip range is stored and then the process of generating a clip image by using the HTML data is performed, the generated image is often different from the image displayed in the webpage image 101. Accordingly, by generating the clip image data CI1, it is possible to securely clip and store the image data displayed in the webpage image 101.

In step S25, the CPU 11 analyzes the HTML data included in the range of the designation area 102 and extracts a character string. Specifically, when the HTML data includes character string data, the CPU extracts the character string data. In addition, when the HTML data includes a data reference tag, the CPU performs the OCR processing on the reference image data referred by the data reference tag, thereby extracting the character string data.

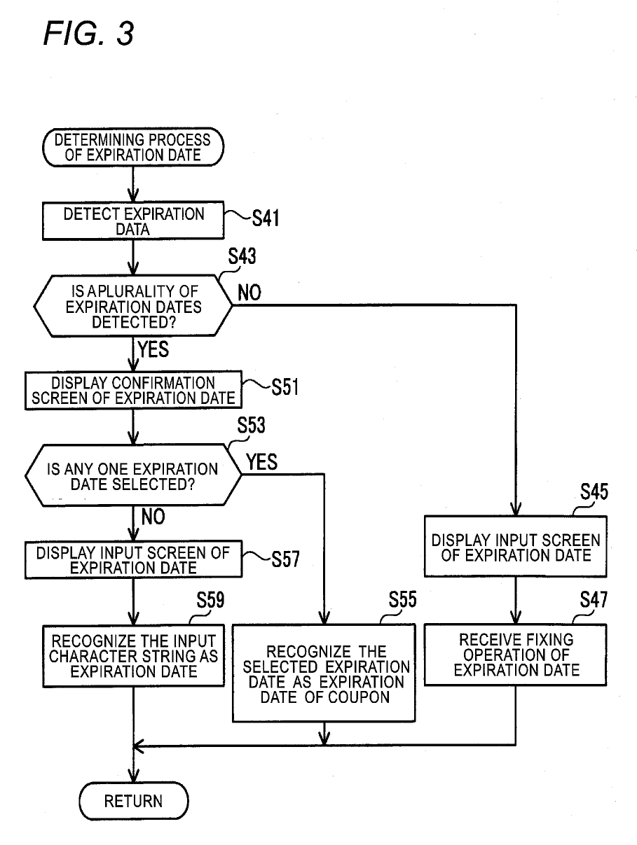

In step S27, the CPU 11 determines the expiration date. The process of determining the expiration date, which is performed in step S27, will be described with reference to FIG. 3. In step S41, the CPU 11 analyzes the extracted character string data to detect the expiration date. Specifically, the CPU searches keywords (for example, 20** year, Heisei (it is name of a Japanese era)** year, * month * date, late-**, until **, and the like) to be associated with the expiration date. When the keywords are detected, the CPU detects the character string data including the keywords, as the expiration date.

In step S43, the CPU 11 determines whether a plurality of expiration dates is detected. When a plurality of expiration dates is not detected (step S43: NO), the processing proceeds to step S45. In step S45, the CPU 11 displays an input screen of the expiration date on the monitor 18. As an example of the input screen, an edit box (a square box-shaped interface for inputting a character string) may be displayed. In addition, when no expiration date is detected, the edit box may be left blank. Also, when only one expiration date is detected, the detected expiration date may be displayed in the edit box. Further, the CPU 11 receives an input operation or change operation of the expiration date, which is performed via the keyboard 17. In step S47, the CPU 11 receives an operation of fixing the expiration date that is performed by the user. In the fixing operation, when the user pushes the Enter key, the character string displayed in the edit box may be fixed as the expiration date.

On the other hand, when a plurality of expiration dates is detected in step S43 (step S43: YES), the processing proceeds to step S51. In step S51, the CPU 11 displays a confirm screen of the expiration dates on the monitor 18. At this time, the CPU 11 displays the plurality of expiration dates as a list.

In step S43, the CPU 11 receives a selection of the expiration dates by the user. When any one expiration date is selected from the list (step S53: YES), the processing proceeds to step S55. In step S55, the CPU 11 recognizes the expiration date selected by the user as the expiration date of the coupon. Then, the processing proceeds to step S29 (FIG. 2).

On the other hand, when any expiration date is not selected from the list in step S53, the CPU 11 determines that the information corresponding to the expiration date of the coupon does not exist in the list, and the processing proceeds to step S57. In step S57, the CPU 11 displays the input screen of the expiration date of the coupon on the monitor 18 and receives a user's input of the expiration date via the keyboard 17. As an example of the input screen, a blank edit box may be displayed. In step S59, the CPU 11 recognizes the character string input in the edit box as the expiration date. Then, the processing proceeds to step S29 (FIG. 2).

In step S29, the CPU 11 stores the clip image data CI1 in the clip application storage area 23a. In addition, the CPU stores the clip information 410 in the clip information table TB1 in correspondence with the clip image data CI1.

A specific example of this illustrative aspect will be described. In FIG. 12, when the designation area 102 is clipped (step S11: YES), the clip image data CI1 of the coupon image 131 is acquired. The clip image data CI1 of the coupon image 131 is determined as a non-single image data type in step S17. In step S25, the character string data “** burger,” “100 Yen” and “expiration date: late-December 2010” included in the HTML data are extracted. In addition, in the process of determining the expiration date (step S27), one expiration date “late-December 2010” is detected (step S43: NO). Then, the edit box having “late-December 2010” displayed therein is displayed on the monitor 18 (step S45). When the user pushes the Enter key of the keyboard 17, the expiration date “late-December 2010” is fixed (step S47). Then, the clip image data CI1 (image data name=“Clip1.jpg”) corresponding to the coupon image 131 is stored in the clip application storage area 23a. In addition, as shown in FIG. 11, the clip information 410 is stored in the column of the identification number 400 being equal to “1” of the clip information table TB1. At this time, the image data name 402 is to be “Clip1.jpg”, so that the clip image data CI1 and the clip information 410 are made to correspond to each other.

### (Display Process of Clip Image Data CI1)

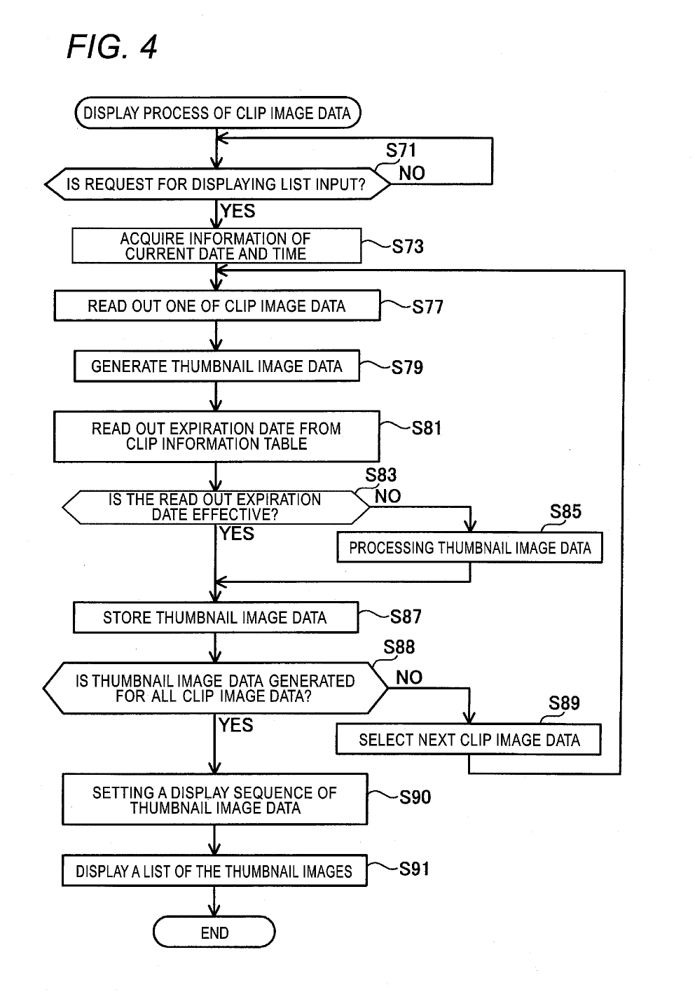

In the followings, a display process of the clip image data will be described with reference to FIG. 4. In step S71, the CPU 11 determines whether the user inputs a request for the list display of the clip image data CI1 stored in the clip application storage area 23a. When the request is not input (step S71: NO), the CPU returns to step S71 and stands by. When the request is input (step S71: YES), the processing proceeds to step S73. In step S73, the CPU 11 acquires information of current date and time.

In step S77, the CPU 11 reads out one of the plurality of clip image data CI1 stored in the clip application storage area 23a. In step S79, the CPU 11 generates thumbnail image data by using the clip image data C11.

The thumbnail image data is reduced image data for roughly perceiving an overall image. In step S81, the CPU 11 reads out the expiration date corresponding to the read clip image data CI1 from the clip information table TB1.

In step S83, the CPU 11 determines whether the read expiration date is effective. Specifically, the CPU 11 compares the read expiration date with the information of current date and time. Then, when the expiration date is earlier than the information of current date and time, the CPU 11 determines that the expiration date has expired. When the expiration date is later than the information of current date and time, the CPU 11 determines that the expiration date is effective. When it is determined that the expiration date has expired (step S83: NO), the processing proceeds to step S85. In step S85, the CPU 11 processes the thumbnail image data into a format noticing the expiration of the expiration date to be recognized. An example of the processing may include the gray out processing of displaying the entire thumbnail image with a light gray color.

On the other hand, when the expiration date is effective (step S83: YES), the CPU skips over step S85 and directly proceeds to step S87. In step S87, the CPU 11 stores the generated thumbnail image data in the temporary storage area of the storage unit 12.

In step S88, the CPU 11 determines whether the thumbnail image data has been generated for all the clip image data CI1 stored in the clip application storage area 23a. When the thumbnail image data has not been generated (step S88: NO), the processing proceeds to step S89, and the CPU selects the next clip image data CI1 from the clip application storage area 23a and then returns to step S77. On the other hand, when the thumbnail image data has been generated for all the clip image data CI1 (step S88: YES), the processing proceeds to step S90.

In step S90, the CPU 11 sets a sequence of displaying the thumbnail image data. In this illustrative aspect, the sequence is set in such a way that the thumbnail image data having the longer expiration date is displayed in the upper of the screen. In step S91, the CPU 11 displays the list of the thumbnail images on the monitor 18.

### (Updating Process of Clip Image Data CI1)

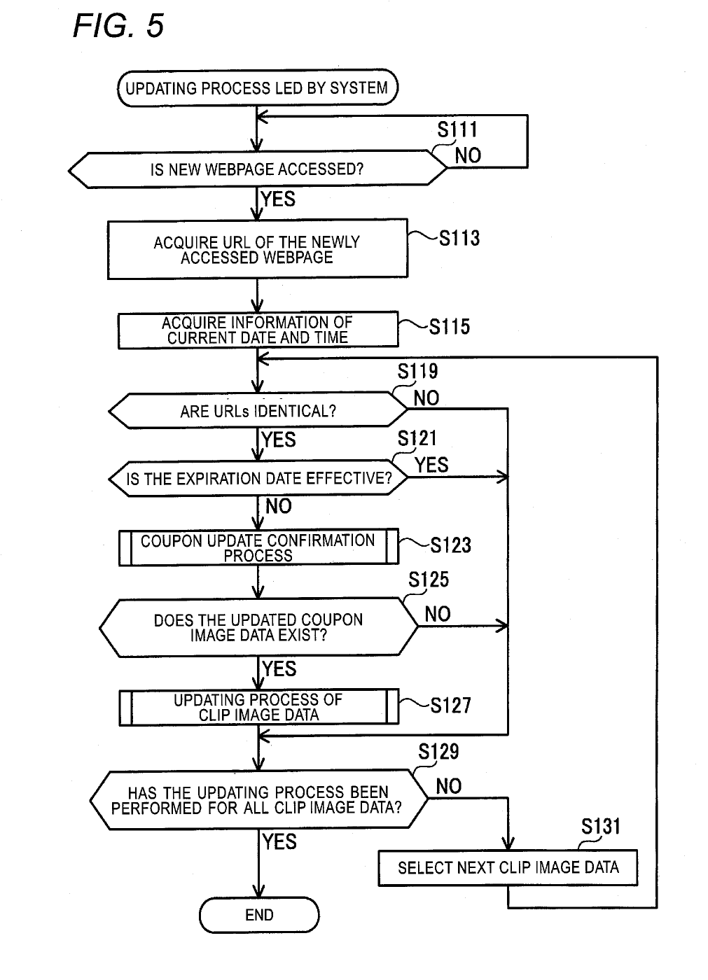

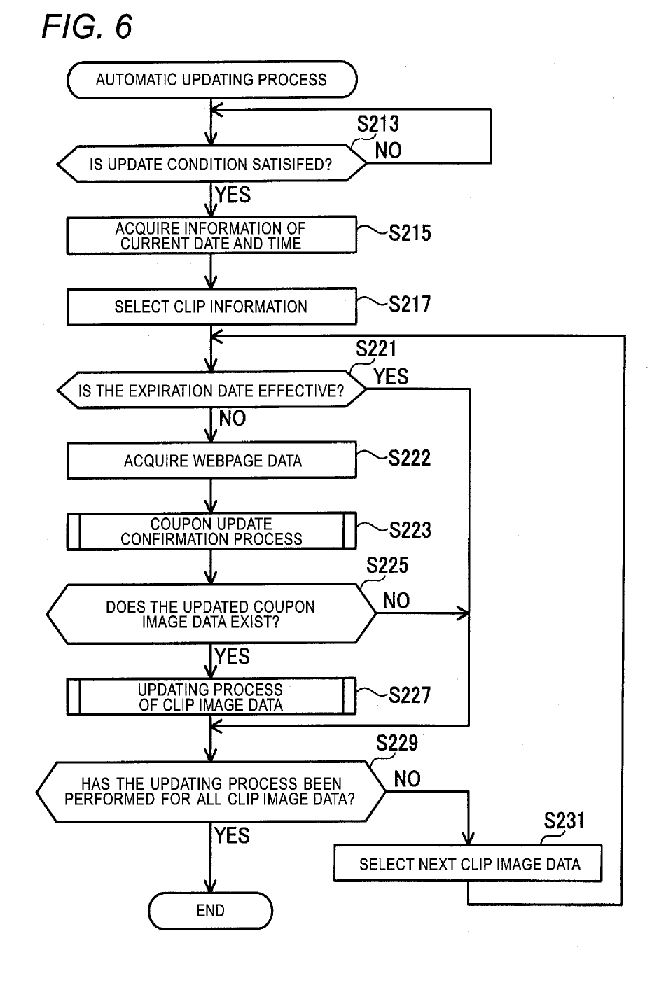

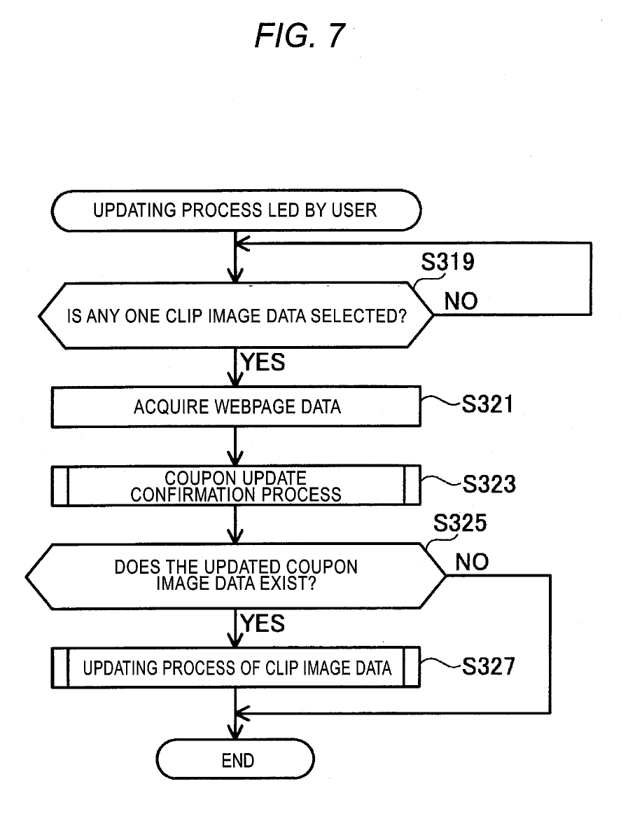

In the followings, an updating process of the clip image data CI1 stored in the clip application storage area 23a will be described. The updating process includes an updating process led by the system (FIG. 5), an automatic updating process (FIG. 6) and an updating process led by the user (FIG. 7). These processes are performed all the time during the operation of the PC 10.

### (Updating Process LED by System)

The operating flow of the updating process led by the system will be described with reference to FIG. 5. In step S111, when executing the process in response to the browser application 21b, the CPU 11 monitors whether a new webpage is accessed. When there is no access to a new webpage (step S111: NO), the CPU returns to step S111 and stands by. When the browser application accesses a new webpage, the CPU 11 acquires the URL of the newly accessed webpage. In step S115, the CPU 11 acquires the information of current date and time.

In step S119, the CPU 11 selects one clip image data CI1 from the clip application storage area 23a and determines whether the URL corresponding to the selected clip image data CI1 is identical with the URL acquired in step S113. When the URLs are not identical (step S119: NO), the processing proceeds to step S129. When the URLs are identical (step S119: YES), the processing proceeds to step S121.

In step S121, the CPU 11 determines whether the expiration date of the clip image data CI1 selected in step S119 is effective. Since the determination method of the expiration date is the same as that described in step S83, the descriptions thereof will be omitted. When the expiration date is effective (step S121: YES), the processing proceeds to step S129. When the expiration date has expired (step S121: NO), the processing proceeds to step S123.

In step S123, the CPU 11 executes a coupon update confirmation process. In the coupon update confirmation process, the CPU determines whether the coupon image data, which has the same content as the clip image data CI1 detected in step S119 and the updated expiration date, exists in the data of the webpage being currently accessed. The expiration date of the coupon image data in the webpage data is updated in many cases, with considering the characteristics of the web media whose data contents can be changed in real time. Accordingly, it is determined whether the coupon image data having the same contents (discount object, discount price and the like) as the clip image data CI1 stored in the clip application storage area 23a and the different expiration date exists in the data of the webpage being currently accessed.

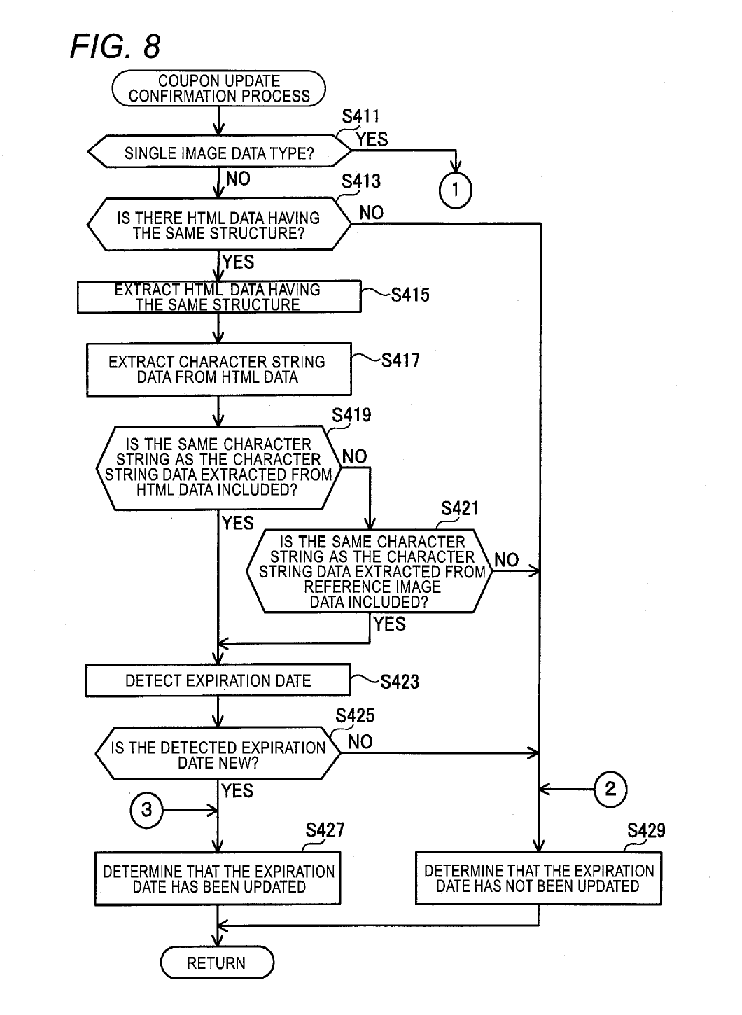

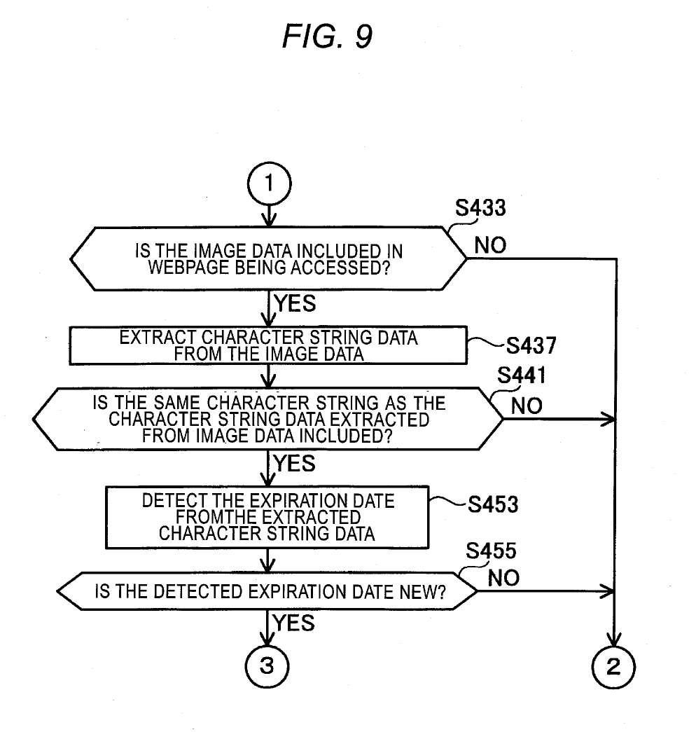

The process of step S123 will be described with reference to FIGS. 8 and 9. In step S411, the CPU 11 determines whether the type of the clip image data CI1 is the single image data type by referring to the image data type 401 of the clip information table TB1. When the type is not the single image data type (step S411: NO), the processing proceeds to step S413. In step S413, the CPU 11 determines whether the webpage data (HTML data) being currently accessed contains the HTML data having the same structure as the clip image data CI1 selected in step S119. When the HTML data having the same structure is not detected (step S413: NO), the processing proceeds to step S429 and determines that the expiration date has not been updated. On the other hand, when the HTML data having the same structure is detected (step S413: YES), the processing proceeds to step S415.

In step S415, the CPU 11 extracts the HTML data having the same structure from the webpage data (HTML data). In step S417, the CPU 11 extracts the character string data from the extracted HTML data. In addition, the CPU performs the OCR processing for the reference image data referred to by the data reference tag in the HTML data, thereby extracting the character string data. In step S419, the CPU 11 determines whether the same character string is included both in the character string data extracted from the HTML data of the webpage data and in the character string data extracted from the clip image data CI1 selected in step S119. When the same character string is included (step S419: YES), the processing proceeds to step S423. When the same character string is not included (step S419: NO), the processing proceeds to step S421.

In step S421, the CPU 11 determines whether the same character string is included both in the character string data extracted from the reference image data of the webpage data and in the character string extracted from the reference image data of the clip image data CI1 selected in step S119. When the same character string is included (step S421: YES), the processing proceeds to step S423. When the same character string is not included (step S421: NO), the processing proceeds to step S429.

In step S423, the CPU 11 analyzes the extracted character string data to detect the expiration date. Since the detection method of the expiration date is the same as the detection method described in step S41, the descriptions thereof will be omitted.

In step S425, the CPU 11 determines whether the expiration date detected in step S423 is newer than the expiration date 404 corresponding to the clip image data CI1. When the expiration date is newer (step S425: YES), the processing proceeds to step S427 and determines that the image data having the same content as the clip image data CI1 detected in step S119 and the updated expiration date exists in the webpage data being currently accessed. On the other hand, when the expiration date is not newer (step S425: NO), the processing proceeds to step S429 and determines that the image data having the updated expiration date with respect to the clip image data CI1 detected in step S119 does not exist in the webpage data being currently accessed. Then, the CPU 11 stores the determination result in the temporary storage area of the storage unit 12 and then proceeds to step S125 (FIG. 5).

In step S411, when the type of the clip image data CI1 is a single image data type (step S411: YES), the processing proceeds to step S433 (FIG. 9). In step S433, the CPU 11 determines whether the image data is included in the webpage being currently accessed. When the image data is not included (step S433: NO), the processing proceeds to step S429 (FIG. 8). When the image data is included (step S433: YES), the processing proceeds to step S437. In step S437, the CPU 11 analyzes the image data in the webpage data by the OCR processing, thereby extracting the character string data.

In step S441, the CPU 11 determines whether the same character string is included both in the character string data extracted from the image data included in the webpage being currently accessed and the character string data extracted from the clip image data CI1 selected in step S119. When the same character string is not included (step S441: NO), the processing proceeds to step S429 (FIG. 8). When the same character string is included (step S441: YES), the processing proceeds to step S453. In step S453, the CPU 11 analyzes the extracted character string data to detect the expiration date.

In step S455, the CPU 11 determines whether the expiration date detected in step S453 is newer than the expiration date 404 corresponding to the clip image data CI1. When the expiration date is not newer (step S455: NO), the processing proceeds to step S429 (FIG. 8). When the expiration date is newer (step S455: YES), the processing proceeds to step S427 (FIG. 8). Then, the CPU 11 stores the determination result in the temporary storage area of the storage unit 12 and then proceeds to step S125 (FIG. 5).

In step S125, the CPU 11 determines whether the coupon image data having the same content as the clip image data CI1 detected in step S119 and the updated expiration date exists in the webpage data. The determination is performed based on the determination result stored in the temporary storage area of the storage unit 12. When the coupon image data does not exist (step S125: NO), the processing proceeds to step S129. When the coupon image data exists (step S125: YES), the processing proceeds to step S127.

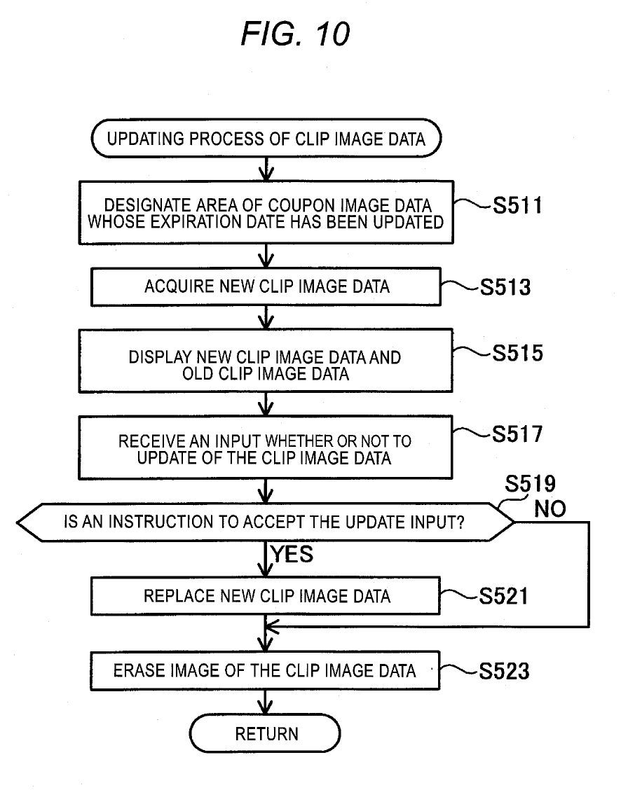

In step S127, the CPU 11 executes the updating process of the clip image data C11. The updating process performed in step S127 will be described with reference to FIG. 10.

In step S511, the CPU 11 designates the area in which the coupon image data having the updated expiration date is displayed from the webpage data being currently accessed. In step S513, the CPU 11 acquires new clip image data CI1 from the designated area. In the meantime, since the method of acquiring the clip image data CI1 is the same as the method described by the flowchart of FIG. 2, the descriptions thereof will be omitted.

In step S515, the CPU 11 displays together the image of the old clip image data CI1 stored in the clip application storage area 23a and the image of the new clip image data CI1 acquired in step S513 on the monitor 18. In step S517, the CPU 11 notifies the user that there is the clip image data CI1 to be updated. Then, the CPU receives an input response to the update from the user. In step S519, the CPU 11 determines whether the user inputs an instruction to accept the update. When the user inputs an instruction not to accept the update (step S519: NO), the CPU skips over the step S521 and proceeds to step S523. When the user inputs an instruction to accept the update (step S519: YES), the processing proceeds to step S521.

In step S521, the CPU 11 replaces the image of the old clip image data CI1 stored in the clip application storage area 23a with the new clip image data CI1 acquired in step S513. In addition, the CPU 11 replaces the clip information 410 of the old clip information table TB1 stored in the clip information table TB1 with the clip information 410 corresponding to the new clip image data CI1. In step S523, the CPU 11 erases the image of the new clip image data CI1 and the image of the old clip image data CI1, which are displayed on the monitor 18. Then, the processing proceeds to step S129 (FIG. 5).

In step S129, the CPU 11 determines whether the updating process has been performed for all the clip image data CI1 stored in the clip application storage area 23a. When the updating process has not been performed (step S129: NO), the processing proceeds to step S131, selects the next clip image data CI1 from the clip application storage area 23a and then returns to step S119. On the other hand, when the updating process has been performed for all the clip image data CI1 (step S129: YES), the flow is to be end.

### (Automatic Updating Process)

In the followings, the automatic updating process of the clip image data CI1 stored in the clip application storage area 23a will be described with reference to FIG. 6. In step S213, the CPU 11 determines whether an update condition is satisfied. The update condition is, for examples, the startup of the clip application 21a, the startup of the PC 10 and the like. When the update condition is not satisfied (step S213: NO), the CPU returns to step S213 and stands by. When the update condition is satisfied (step S213: YES), the processing proceeds to step S215.

In step S215, the CPU 11 acquires the information of current date and time. In step S217, the CPU 11 selects the clip information 410 that is made to correspond to the identification number 400 being equal to “1” of the clip information table TB1. In step S221, the CPU 11 compares the expiration date 404 of the selected clip information 410 with the information of current date and time. Then, the CPU determines whether the expiration date 404 is effective. When the expiration date is effective (step S221: YES), the processing proceeds to step S229. When the expiration date has expired (step S221: NO), the processing proceeds to step S222.

In step S222, the CPU 11 acquires the webpage data by using the URL 403 of the clip information 410. At this time, the CPU 11 acquires the webpage data by the background processing and does not display the webpage image on the monitor 18.

In step S223, the CPU 11 executes the coupon update confirmation process. In the coupon update confirmation process, the CPU determines whether the image data, which has the same content as the selected clip image data CH and the updated expiration date, exists in the webpage data being currently accessed. In the meantime, since the detailed description of the coupon update confirmation process is the same as that of step S123, the descriptions thereof will be omitted.

In step S225, the CPU 11 determines whether the image data, which has the same content as the selected clip image data CI1 and the updated expiration date, exists in the webpage data. When the image data does not exist (step S225: NO), the processing proceeds to step S229. When the image data exists (step S225: YES), the processing proceeds to step S227. In step S227, the CPU 11 executes the updating process of the clip image data CI1. In the meantime, since the detailed description of the updating process is the same as that of step S127, the descriptions thereof will be omitted.

In step S229, the CPU 11 determines whether the updating process has been performed for all the clip image data CI1 stored in the clip application storage area 23a. When the updating process has not been performed (step S229: NO), the processing proceeds to step S231, selects the next clip image data CI1 from the clip application storage area 23a and then returns to step S221. On the other hand, when the updating process has been performed for all the clip image data CI1 (step S229: YES), the flow is to be end.

### (Updating Process LED by User)

The updating process of the clip image data CI1 stored in the clip application storage area 23a led by the user, will be described with reference to FIG. 7. In step S319, the CPU 11 determines whether any one of the clip image data CI1 stored in the clip application storage area 23a is selected by the user. An example of the method of receiving the selection is a method of receiving the click on any one thumbnail image when the list of the thumbnail images of the clip image data CI1 is displayed on the monitor 18 by the process of step S91. When the clip image data is not selected (step S319: NO), the CPU returns to step S319 and stands by. When the clip image data is selected (step S319: YES), the processing proceeds to step S321.

In step S321, the CPU 11 acquires the webpage data by using the URL 403 of the clip information 410 associated with the selected clip image data C11. At this time, the webpage data is acquired by the background processing. In step S323, the CPU 11 executes the coupon update confirmation process. In the coupon update confirmation process, the CPU determines whether the coupon image data, which has the same content as the selected clip image data CI1 and the updated expiration date, exists in the webpage data being currently accessed.

In step S325, the CPU 11 determines whether the image data having the same content as the selected clip image data CI1 and the updated expiration date exists in the webpage data. When the image data does not exist (step S325: NO), the CPU ends the flow. When the image data exists (step S325: YES), the processing proceeds to step S327. In step S327, the CPU 11 executes the updating process of the clip image data CI1.

### (Effects)

The effects of the clip application 21a according to this illustrative aspect will be described. In the clip application 21a of the present invention, the clip image data CI1 having the latest term information can be stored in the clip application storage area 23a at the all time. In other words, based on the term information, it is possible to manage the clip image data CI1. Accordingly, it is possible to prevent a user from using the clip image data CI1 associated with the old term information.

In the clip application 21a, the thumbnail image data of the clip image data CI1 whose expiration date has expired is, for example, gray-out-displayed so that the user can recognize it in step S91. Thereby, the user can easily recognize the clip image data CI1 having the term information whose expiration date has expired, as visual information. Accordingly, it is possible to increase the user's convenience.

In the clip application 21a, in step S319, when the user just selects the clip image data CI1 to be updated, the clip image data CI1 having the new term information is to be updated. Accordingly, since it is possible to simplify the updating operation, it is possible to reduce the operation burden of the user.

In the clip application 21a, when the user accesses the providing source of the various webpage data by using the browser application 21b, the updating process of the clip image data CI1 is executed (step S127) according to the access to the webpage data having acquired the clip image data CI1 (step S119: YES). Thus, since the updating process is performed while the user does not again perform an operation for the update, it is possible to reduce the operation burden of the user.

In the clip application 21a, the updating process of the clip image data CI1 is executed at the predetermined timing (step S213) such as startup of the computer, for example. Accordingly, since the updating process is automatically performed while the user does not perform the updating operation, it is possible to reduce the operation burden of the user.

In the clip application 21a, it is possible to extract the term information from the clip image data CI1 (step S21, step S25). Accordingly, since it is possible to reduce the input operation of the term information by the user, it is possible to increase the user's convenience.

Although the illustrative aspect of the present invention has been described in detail, it is just illustrative example and does not limit the scope of the present invention. The present invention includes a variety of modifications and changes to the above illustrative aspect.

### (Modified Aspects)

In step S90 of the above illustrative aspect, the display aspect of the thumbnail image data has been set based on the expiration date. However, the present invention is not limited thereto. For example, the clip image data CI1 having a common attribute may be extracted. In addition, the thumbnail images having common attributes may be collected and displayed on the monitor 18 for each of groups. The common attributes may include a commonality of a providing source of the webpage data. Specifically, with respect to the URL 403 of the clip information 410, the clip image data CI1 having common attributes “**.co.jp” or “**.com” may be extracted. Thereby, a user can easily perceive the clip image data CI1 having the common attribute. Accordingly, it is possible to increase the user's convenience.

In step S41 of the above illustrative aspect, the process of detecting the expiration date is based on the keywords. However, the present invention is not limited thereto. For example, a clip image that is generated by the clip image data CI1 may be displayed on the monitor 18, and a user may be enabled to further clip an area in which the expiration date is displayed in the clip image. Thereby, since the determination process of the expiration date is performed for the designated range of the clip image data CI1, it is possible to perform the determination more precisely. In addition, since the user just clips the range in which the term information is displayed by using the mouse 19 and the like, it is possible to reduce the operation burden of the user, compared with a case where the user inputs the term information by using the keyboard 17 and the like. Accordingly, it is possible to improve the precision of the determination process of the expiration date while simplifying the operation of the determination process of the expiration date.

In the above illustrative aspect, the detection method performed in step S423 is the same as the detection method performed in step S41. However, the present invention is not limited thereto. A different detection method, which obtains the same result as the detection method performed in step S41, may be performed in step S423. [0095] In the illustrative aspect, the coupon has been exemplified as an example of the information having the fixed expiration date. However, the present invention is not limited thereto. For example, event information and the like may be used.

The updating process that is performed in step S127 is not limited to the flow shown in FIG. 10. In step S515, both the image of the old clip image data CI1 and the image of the new clip image data CI1 are displayed together on the monitor 18. However, it may be possible to prompt a user to input an instruction accepting the update without displaying the images. In addition, in step S517, the user is notified that there is clip image data CI1 to be updated and the user is prompted to input an instruction accepting the update. However, when the new clip image data CI1 is acquired, the update may be performed without noticing the user whether or not to perform the update.

In the illustrative aspect, the clip application 21a is used in the PC 10. However, the present invention is not limited thereto. For example, the clip application 21a may be used in, for example, a portable telephone or multifunction peripheral.

The input of the designation area 102 is not limited to the aspect of using the input device such as mouse 19 and the like. For example, if the monitor 18 is configured by a touch panel, the designation area 102 may be designated by a finger, a pen and the like. In addition, the shape of the designation area 102 is not limited to the rectangular shape. For example, the shape of the designation area may be parallelogram or circular.

In addition, the technical elements described and shown in the specification and the drawings provide the technical usefulness independently or in combination and are not limited to a combination of the above description. Further, the technologies exemplified in the specification or drawings achieve a plurality of purposes at the same time, and a technical usefulness is realized by achieving one of proposes.

In the meantime, the PC 10 is an example of a computer. The web server 71 is an example of a providing source of the webpage data. The HTML data is an example of the webpage data. The browser application 21b is an example of the webpage display unit. The clip application storage area 23a and the clip information table TB1 are examples of the storage unit. The coupon image is an example of the specific image. The expiration date is an example of the term information. The clip image data CI1 is an example of the specific image data. The URL is an example of the specific information.

In addition, the control unit executing the process of step S11 is an example of the designation receiving unit. The control unit executing the processes of step S13, step S23 and step S29 is an example of the determining unit. The control unit executing the process of step S521 is an example of the replacing unit. The control unit executing the process of step S91 is an example of the display unit. The control unit executing the process of step S319 is an example of the operation receiving unit. The control unit executing the process of step S119 is an example of the monitoring unit. The control unit executing the process of step S222 is an example of the access unit. The control unit executing the processes of step S45 and step S57 is an example of the input receiving unit.

What is claimed is:

1. A non-transitory computer-readable medium having instructions to control a computer, which is configured to display an image represented by webpage data, which is provided from a providing source of the webpage data, on a display unit, to perform a method of image forming control, the method comprising:
controlling, when an operation unit receives a operation designating a specific image that is a partial image being at least a part of the webpage image, a first acquiring unit to acquire the term associated with the specific image received by the operation unit;
controlling a storage unit to store:
term information indicating the term acquired by the first acquiring unit;
term acquiring information to acquire the term from the webpage data by the same process as the first acquiring unit;
specific image data acquiring information to acquire specific image data corresponding to the specific image from the webpage data; and
webpage data specifying information to specify either webpage data;
controlling, when the webpage data specified by the webpage data specifying information is provided by the providing source, a second acquiring unit to acquire the term from said webpage data, by using the term acquiring information stored in the storage unit; and
controlling, when the term acquired by the second acquiring unit is updated from the term indicated by the term information, a specific image data acquiring unit to acquire the specific image data from the webpage data, by using the specific image data acquiring information stored in the storage unit.

2. The non-transitory computer-readable medium according to claim 1,
wherein the controlling the storage unit controls the storage unit to store the term acquiring information and the specific image data acquiring information as shared information.

3. The non-transitory computer-readable according to claim 1, the method further comprising:
controlling the storage unit to store correspondence information, which indicates a correspondence between the term information indicating the term acquired by the second acquiring unit and the specific image data acquired by the specific image data acquiring unit, and
controlling the display unit to display so that a displaying aspect of the specific image data, which is stored in the storage unit and is corresponding to the term information indicating after a current time, is different from a displaying aspect of the specific image data, which is stored in the storage unit and is corresponding to the term information indicating before the current time.

4. The non-transitory computer-readable medium according to claim 1, the method further comprising:
controlling, when the operation unit receives the operation designating the specific image stored in the storage unit, a providing request unit to make the providing source provide the webpage data, which is an acquiring source of the specific image data, by using the webpage data specifying unit stored in the storage unit.

5. The non-transitory computer-readable medium according to claim 1, the method further comprising:
controlling, when the webpage data acquiring unit acquires webpage data and when the webpage data is specified by the webpage data specifying information stored in the storage unit, to acquire the term from the webpage data acquired the webpage data acquiring unit, by using the term acquiring information stored in the storage unit.

6. The non-transitory computer-readable medium to claim 1, the method further comprising:
controlling, when the term indicated by the term information stored in the storage unit is expired, a providing request unit to make the providing source provide the webpage data, which is an acquiring source of the specific image data, corresponding to the term information; and
controlling, when the webpage data, which is provided from the providing source by the providing request unit, the second acquiring control unit to acquire the term from the webpage data, by using the term acquiring information stored in the storage unit.

7. The non-transitory computer-readable medium according to claim 1, the method further comprising:
controlling the first acquiring unit to acquire the term based on a character image, which is included in the specific image received by using the operation unit, or a character data, which is included in the specific image data corresponding to the specific image.

8. The non-transitory computer-readable medium according to claim 7, the method further comprising:
controlling, when the operation unit receives the operation designating a term area representing the term in the specific image, the first acquiring unit to acquire the term based on the character image, which is included in the term area of the specific image received by using the operation unit, or the character data, which is included in the specific image data corresponding to the term area.

9. The non-transitory computer-readable medium according to claim 1, the method further comprising:
controlling, when the operation unit receives the operation designating the term, the first acquiring unit to acquire the term designated by operation received by the operation unit.

10. A method of image forming control comprising:
displaying an image represented by webpage data, which is provided from a providing source of the webpage data, on a display unit;
controlling, when an operation unit receives a operation designating a specific image associated with term that is a partial image being at least a part of the webpage image, a first acquiring unit to acquire the term associated with the specific image received by the operation unit;
controlling a storage unit to store:
term information indicating the term acquired by the first acquiring unit;
term acquiring information to acquire the term from the webpage data by the same process as the first acquiring unit;
specific image data acquiring information to acquire specific image data corresponding to the specific image from the webpage data; and
webpage data specifying information to specify either webpage data;
controlling, when the webpage data specified by the webpage data specifying information is provided by the providing source, a second acquiring unit to acquire the term from said webpage data, by using the term acquiring information stored in the storage unit; and
controlling, when the term acquired by the second acquiring unit is updated from the term indicated by the term information, a specific image data acquiring unit to acquire the specific image data from the webpage data, by using the specific image data acquiring information stored in the storage unit.

11. The method according to claim 10,
wherein the controlling the storage unit controls the storage unit to store the term acquiring information and the specific image data acquiring information as shared information.

12. The method according to claim 10, the method further comprising:
controlling the storage unit to store correspondence information, which indicates a correspondence between the term information indicating the term acquired by the second acquiring unit and the specific image data acquired by the specific image data acquiring unit, and
controlling the display unit to display so that a displaying aspect of the specific image data, which is stored in the storage unit and is corresponding to the term information indicating after a current time, is different from a displaying aspect of the specific image data, which is stored in the storage unit and is corresponding to the term information indicating before the current time.

13. The method according to claim 10, the method further comprising:
controlling, when the operation unit receives the operation designating the specific image stored in the storage unit, a providing request unit to make the providing source provide the webpage data, which is an acquiring source of the specific image data, by using the webpage data specifying unit stored in the storage unit.

14. The method according to claim 10, the method further comprising:
controlling, when the webpage data acquiring unit acquires webpage data and when the webpage data is specified by the webpage data specifying information stored in the storage unit, to acquire the term from the webpage data acquired the webpage data acquiring unit, by using the term acquiring information stored in the storage unit.

15. The method according to claim 10, the method further comprising:
controlling, when the term indicated by the term information stored in the storage unit is expired, a providing request unit to make the providing source provide the webpage data, which is an acquiring source of the specific image data, corresponding to the term information; and
controlling, when the webpage data, which is provided from the providing source by the providing request unit, the second acquiring control unit to acquire the term from the webpage data, by using the term acquiring information stored in the storage unit.

16. The method according to claim 10, the method further comprising:
controlling the first acquiring unit to acquire the term based on a character image, which is included in the specific image received by using the operation unit, or a character data, which is included in the specific image data corresponding to the specific image.

17. The method according to claim 16, the method further comprising:
controlling, when the operation unit receives the operation designating a term area representing the term in the specific image, the first acquiring unit to acquire the term based on the character image, which is included in the term area of the specific image received by using the operation unit, or the character data, which is included in the specific image data corresponding to the term area.

18. The non-transitory computer-readable medium according to claim 10, the method further comprising:
controlling, when the operation unit receives the operation designating the term, the first acquiring unit to acquire the term designated by operation received by the operation unit.

19. A image processing apparatus comprising:
a webpage display unit configured to display an image represented by webpage data, which is provided from a providing source of the webpage data, on a display unit;
a first acquiring control unit that controls, when an operation unit receives a operation designating a specific image associated with term that is a partial image being at least a part of the webpage image, a first acquiring unit to acquire the term associated with the specific image received by the operation unit;
a storage control unit that controls a storage unit to store:
term information indicating the term acquired by the first acquiring unit;
term acquiring information to acquire the term from the webpage data by the same process as the first acquiring unit;
specific image data acquiring information to acquire specific image data corresponding to the specific image from the webpage data; and
webpage data specifying information to specify either webpage data;
a second acquiring control unit that controls, when the webpage data specified by the webpage data specifying information is provided by the providing source, a second acquiring unit to acquire the term from said webpage data, by using the term acquiring information stored in the storage unit; and
a specified image data acquiring control unit that controls, when the term acquired by the second acquiring unit is updated from the term indicated by the term information, a specific image data acquiring unit to acquire the specific image data from the webpage data, by using the specific image data acquiring information stored in the storage unit.
